(19) United States
(12) Patent Application Publication
(10) Pub. No.: US 2002/0161957 A1
(43) Pub. Date: Oct. 31, 2002

(54) Methods and systems for handling interrupts

(76) Inventors: Guillaume Comeau, Meteore Hull (CA); Vincent Deschenes, Ottawa (CA)

Correspondence Address: Zucotto Wireless, c/o Mark Wardas, Ste. 400, 4225 Executive Square, La Jolla, CA, 92037, US

(21) Appl. No.: 09/780,039

(22) Filed: Feb. 9, 2001

(51) Int. Cl. G06F 13/24

(52) U.S. Cl. 710/260

(57) ABSTRACT

A processor/processing arrangement, such as a Java or Java like processing environment is provided with simplified the processing of received interrupts received. Rather than having interrupt service routines run by an operating system, a scheduler is provided for performing thread switching between various application layer threads, the application layer threads including application layer threads designated to handle interrupts, and also including conventional application threads. In the processing environment, the application layer threads including the application and interrupt handling threads would all be threads running on a virtual machine.

### FIELD OF THE INVENTION

The invention relates to methods and systems for handling interrupts, for example for handling interrupts from hardware peripherals which interface with a processor (application specific integrated circuit) running a Java or Java like virtual machine.

### BACKGROUND OF THE INVENTION

Typical software systems include an application program run by an operating system on a processor connected to a number of hardware peripherals. In some systems, such as those where a Java or Java like language is employed, there is additionally a virtual machine such as a Java of Java like virtual machine (JVM) situated between the operating system and the application program. Java or Java like code may be executed by the virtual machine, essentially a byte-code interpreter. Java™, is a programming language marketed by Sun Microsystems, Inc. Java is an architecture-neutral, object-oriented, multi-threaded language intended for use in distributed environments. It has become tremendously popular among application developers, and its use on handheld and wireless platforms has been growing by leaps and bounds. Java or Java like programming language may include, but are not limited to Java 2 Platform, Enterprise Edition (J2EE™), Java 2 Platform, Standard Edition (J2SE™), Java 2 Platform, Micro Edition (J2ME™) programming languages available from Sun Microsystems, and C# available from Microsoft Corporation. Both J2SE and J2ME both provide a platform with a standard set of Java programming features, with J2ME providing a subset of the features of J2SE for programming platforms that have limited memory and power resources (i.e., including but not limited to cell phones, PDAs, etc.), while J2EE is targeted at enterprise class server platforms.

In order to facilitate communication with the hardware peripherals, nearly all complex software systems include a device driver which is specific to each hardware peripheral. These device drivers provide a layer of abstraction to their clients (the operating system and ultimately the application program) while allowing them to use the underlying hardware peripherals.

However, device drivers are notoriously difficult to debug or troubleshoot due to the asynchronous nature of their coupling with interrupts and due the lack of debugging features. A faulty driver can also inhibit user input and/or user output. At interrupt levels, the system cannot provide support for the common user state input/output functionality. Furthermore, since timing is often critical, it is impossible to stop a processor and trace device driver code in a non-destructive way. Also, because of the way systems are developed, frequently different development teams are responsible for different layers of a design. When interface problems develop, it is often difficult to determine where the problem originated and hence which team should fix the problem.

Consequently, device drivers take more time to develop and their opacity makes them more error-prone. One of the most common errors which may occur during driver development is an error in pointer arithmetic which instructs the processor to access an erroneous location. Systems generally allow this initially and operation resumes without any apparent disturbance until a later point in time where the value in question is used.

While this is not a big problem for large computing platforms with standardized peripheral interfaces, and a standardized layered architecture, it becomes a very serious problem for application specific hardware and devices where for each new design, the application peripheral path must be debugged from scratch.

Common safeguard measures against pointer arithmetic errors include software range checking. Some languages, such as Java, have inherent measures which prevent invalid memory accesses. However, using the built-in range checking of standard Java to develop device drivers is currently impossible as one of the fundamental characteristics of Java is that any client machine should be protected from corruption/bugs in Java, i.e. any bug in a Java application should only effect the Java application and should have no effect on other applications and memory unrelated to the Java application. To achieve this level of security, Java applications running on the JVM are not given direct access to memory. Instead, memory access is done through an indirection mechanism through the JVM.

Referring now to FIG. 1, a conventional embedded environment 3 typically has hardware 2, software in the form of native code 4 (or assembly language), and software in the form of a Java application 6. Also shown are externally connected hardware peripherals 8. The hardware 2 consists of a processor core 10, memory in the form of RAM 12 and/or ROM 14 and one or more physical interfaces 18 including for example a serial port 27. The software 4 running on the processor 10 includes an operating system 20 over top of which is run a Java virtual machine 22 as a task, and also over which other tasks such as an event dispatcher task 23 is run. The Java application 6 uses the resources and features of the Java virtual machine 22.

FIG. 1 also shows the details of a typical path from the Java application 6 to and from a particular hardware peripheral 8 which for the purpose of this example we will assume is the serial port peripheral 26 connected through the serial port 27. The Java application 6 includes functionality 28 for either generating data ultimately for output to the serial port 27, or for processing data ultimately received from the serial port 27. Of course the functionality 28 does not interact with the serial port 27 directly. The Java virtual machine 22 has a Java native interface 30 through which the Java application 6 communicates with the serial port physical interface 27. The operating system 20 has a serial port device driver 32 which has an input queue 34 and an output queue 36, through which it communicates with the underlying hardware 2. The serial port device driver 32 is typically run at interrupt level, or through a deferred procedure call within the operating system kernel (not shown). More specifically, the serial port device driver 32 communicates with the serial port 27 through serial port memory mapped registers 56 to an input queue 38 and an output queue 40 and on to the hardware peripheral 26. The operating system 20 also has an IRQ (interrupt request) handler 33 for each interrupt from any hardware peripheral.

When the Java application 6 has to communicate with the hardware peripherals 8 and in this case the serial port peripheral 26, a path such as that consisting of the serial port communications 28→Java virtual machine 22→Java native interface 30→operating system 20→serial port device driver 32→serial port physical interface 27→serial port hardware peripheral 26 must be established and debugged for each different hardware peripheral. More specifically, when the Java application 6 has data to send to the serial port peripheral 28, the Java application 6 communicates with the device driver 32 using the Java native interfaces 30. The JNI 30 takes the data, formats it and passes it on to the device driver 32 by copying it into the output buffer 34. The serial port device driver 32 transfers the data to the serial port memory mapped registers 56 of the serial port 27. These are copied into the hardware queue 38 in the serial port 27 for output.

When the serial port 27 receives data destined for the Java application 6, an even more complicated path is taken. For communication originating from the hardware, the process typically goes as follows. To begin, the arrival of data at the serial port 27 triggers the assertion of a hardware interrupt. When this occurs, the program flow is interrupted, and the IRQ handler 33 starts an interrupt service routine. The interrupt service routine calls the serial port device driver 32 which reads the data from the hardware input queue 40 in the serial port 27 and copies it into the input queue 36 which is one of the device driver's data structures. The serial port device driver 32 then posts an event to the event dispatcher task 23. The interrupt service routine returns and normal Java operation resumes. The event dispatcher task 23 sends an event to one of the destination threads 6 to read from the input queue 36 of the serial port device driver 32, for example through a piping mechanism provided by the JNI 30.

It can be clearly seen that there are a large number of areas where bugs may make their way into the design of such a Java application—hardware peripheral interaction. Furthermore, each copying stage forces power consuming and processor intensive operations which are inevitable due to the abstractions of the operating system 20 and the JVM 22.

### SUMMARY OF THE INVENTION

It is an object of the invention to obviate or mitigate one or more of the above-identified disadvantages. The embodiments of the invention may utilized with virtual machines, applications, objects, classes, threads, and data structures offering Java or Java like functionality.

In order to simplify the processing of interrupts received in a processing environment such as a Java or Java like processing environment, rather than having interrupt service routines run by an operating system, a scheduler is provided for performing thread switching between various application layer threads, the application layer threads including application layer threads designated to handle interrupts, and also including conventional application threads. In the processing environment, the application layer threads including the application and interrupt handling threads may be threads running on a virtual machine.

For Java implementations, since the interrupts will be processed as Java of Java like instructions, it will be possible to do development of the interrupt handling Java or Java like threads in a convenient and efficient manner. There is no cumbersome operating system in the middle which would add to the complexity of the system. This also simplifies real-time engineering of the processor.

To interface between hardware and the threads, an interrupt service routine function may be provided which is adapted to receive the interrupts, and upon receipt of an interrupt to cause the scheduler to awaken a thread designated to handle the interrupt.

There may be a respective interrupt thread for each interrupt/interrupt source. Alternatively there may be a respective thread for each of a number of different priorities which is run whenever any interrupt having that priority occurs. Such a thread might call an interrupt specific application layer function to handle the particulars of the interrupt.

The scheduler may perform thread switching upon the basis of a thread priority assigned to each thread. For example, each time the scheduler is invoked, the scheduler may identify whether there is a thread which is waiting to be run which has a higher priority than the currently executing thread, and if so, the scheduler performs a thread switch to that thread.

A thread status table may be maintained by the scheduler for storing a status and priority for each Java thread. The interrupt service routine may cause the scheduler to awaken a thread designated to handle a particular interrupt by changing the thread's status such that the next time the scheduler runs, it will switch to the designated thread.

For example, each thread might have a status which is either WAITING, QUEUED meaning it is waiting to be run, or RUNNING meaning that it is currently executing.

Other embodiments provide a processor adapted to process interrupts with application layer threads; an interrupt service routine adapted to be activated upon an interrupt event, and to activate an application layer thread to handle the interrupt event, without clearing the interrupt event; a Java thread scheduler, and an application layer thread adapted to handle an interrupt event by running to completion or until pre-emption by a higher priority application layer thread, and adapted to clear the interrupt event upon completion.

Any suitable processing arrangement which may be adapted to achieve these functions may be used. For example, but not limited to processors (for example in the form of an integrated circuit, application specific integrated circuit, field programmable gate array), hardware in combination with suitable internally or externally stored software, etc.

### BRIEF DESCRIPTION OF THE DRAWINGS

Preferred embodiments of the invention will now be described with reference to the attached drawings in which:

FIG. 1 is a block diagram of a conventional Java environment;

FIG. 2A is an example of an environment including an interrupt handling mechanism provided by an embodiment of the invention;

FIG. 2B is a state diagram for the environment at FIG. 2A;

FIG. 3 is a thread status table used by the scheduler of FIG. 2A;

FIG. 4 is an interrupt service table used by the interrupt service routine of FIG. 2A;

FIG. 5 is a flowchart of the functionality of the scheduler of FIG. 2A;

FIG. 6 is a flowchart of the functionality of how the environment of FIG. 2A might be initialized;

FIG. 7 is a flowchart of the functionality of the interrupt service routine of FIG. 2A;

FIG. 8 is an example of how the interrupt handling mechanism of FIG. 2 handled nested interrupts; and

FIG. 9 is an example implementation for which the pseudocode is provided in Appendix A.

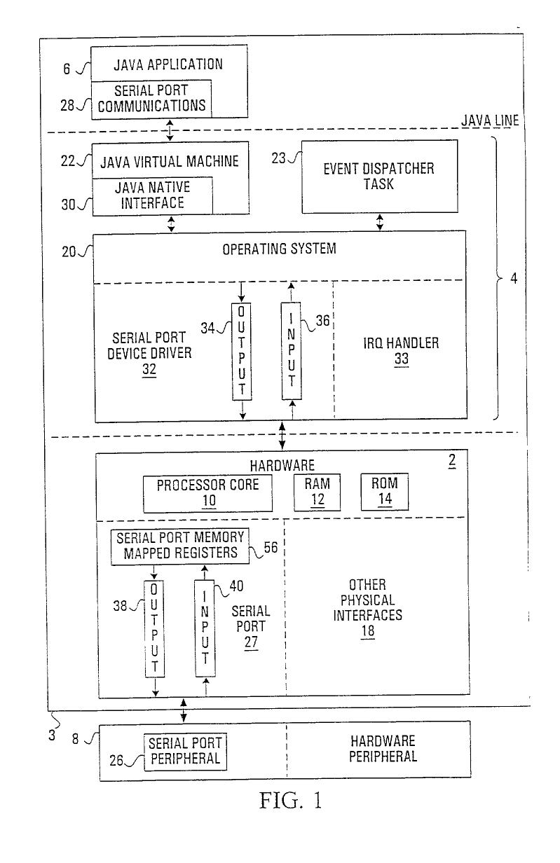

### DETAILED DESCRIPTION OF THE PREFERRED EMBODIMENTS

According to an embodiment of the invention, rather than over a full operating system, a virtual machine is implemented to run directly on hardware, with the assistance of a support layer which acts like a relay for events between the hardware and interrupt service threads implemented in Java.

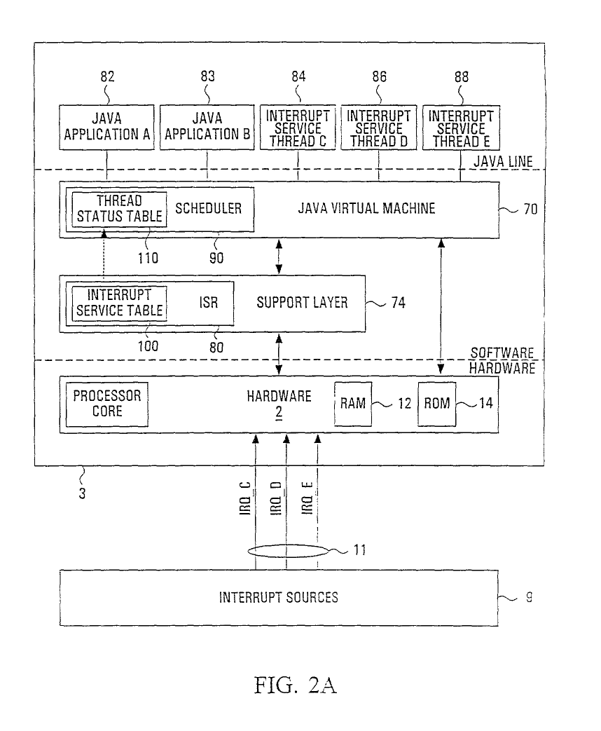

Referring to FIG. 2A, there is shown an apparatus or hardware 2 and, connected thereto, a box labelled “interrupt sources” 9 which represents entities connected to the hardware 2 with interrupt generation capabilities. Typically, hardware peripherals would fall under the interrupt source umbrella. Interrupts 11 are generated by the interrupt sources. Typically, each interrupt is a certain condition on a respective wire of the processor hardware 2. In the illustrated example, the interrupts 11 include IRQ_C, IRQ_D, and IRQ E.

A support layer 74 runs on the hardware 2, and includes an interrupt service routine (ISR) 80. A virtual machine, for example, a Java or Java like virtual machine (JVM) 70 runs with the assistance of the support layer 74. Running on the JVM 70 are a series of Java threads including two application threads identified as Java application A 82 and Java application B 83 and a number of interrupt service threads, one for each interrupt 11 identified as interrupt service thread C 84, interrupt service thread D 86, and interrupt service thread E 88. The JVM 70 is equipped with a scheduler 90 which determines which thread to run and when to perform time slicing between threads.

The support layer 74 comprises native code functions which support the processing of interrupts which are described in detail below. It may also include other features such as some I/O functionality, booting, and initialization of the JVM 70.

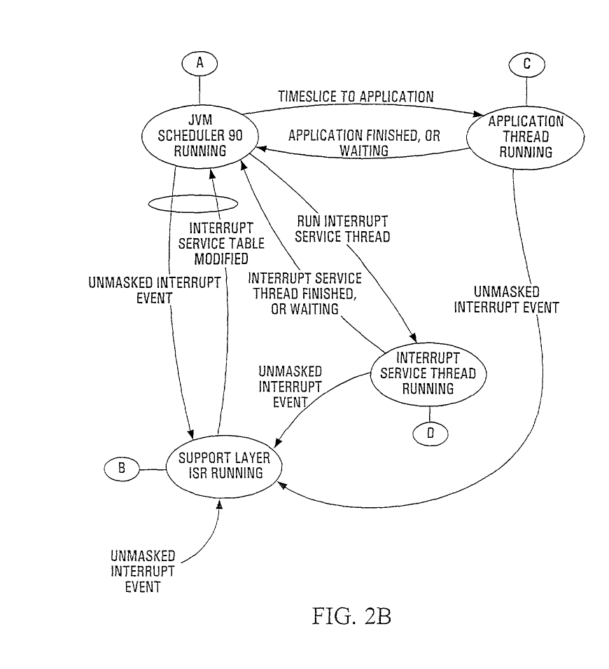

The Java scheduler 90 has a thread status table generally indicated by 110 with three columns listing all of the threads. The details of the thread status table 110 are shown in FIG. 3. In the left hand column 112, the thread identifiers are listed. These include application threads, and also include the various interrupt service threads. In the second column 114, a corresponding priority for each thread is listed. Many prioritization schemes may of course be employed. In the illustrated embodiment, priorities can be either “1” for high priority interrupt, “2” for medium priority interrupt or “3” for low priority interrupt, and “4” for the lowest priority, namely that of an application thread. In the illustrated example, the application threads have priority “4”, while the interrupt service thread C has priority “1” and interrupt service threads D and E have priority “2”. Finally, in the third column 116, each thread has a corresponding status which indicates the respective thread to be either in the “QUEUED”, “RUNNING” or “WAITING” state. Only a single thread is in the RUNNING state at any given instant, namely the thread currently being executed. Any threads which are QUEUED are awaiting a slice of the processors time. Threads which are WAITING are not running, and are not awaiting a slice of time. In the illustrated example, application thread A is RUNNING, application thread B is QUEUED, and the interrupt service threads are all WAITING.

In the illustrated example, there is a separate interrupt service thread for each different interrupt. Alternatively, there may be a separate interrupt service thread for each interrupt priority. An example of this implementation is provided below. This would require fewer interrupt service threads in general which in turn would require less stack space.

FIG. 2B is a state diagram summarizing the activity of the processing environment of FIG. 2A. At any given instant, either the JVM scheduler 90 is running as indicated by state A, the ISR function 80 within the support layer 74 is running as indicated by state B, an application thread (such as one of threads 82,83) is running as indicated by state C, or an interrupt service thread (such as one of interrupt service threads 84,86,88) is running as indicated by state D. Any other functions which might be implemented by the support layer 74 are not shown for the sake of simplicity.

A transition from state A to state B occurs when an unmasked interrupt event occurs. A transition from state A to state C occurs when the JVM scheduler 90 decides to give a time slice to an application thread. A transition from state A to state D occurs when the JVM scheduler 90 decides to run an interrupt service thread.

A transition from any state (A, C or D) to state B occurs as a result of an unmasked interrupt event. After the support layer ISR 80 deals with this, there is a transition back to state A which decides what to run next.

A transition from state C to state A occurs when an application thread either completes (terminates) or goes to the WAITING state, waiting for some event to occur such as an I/O.

A transition from state D to state A occurs when the interrupt service thread goes back to WAITING or when it is done.

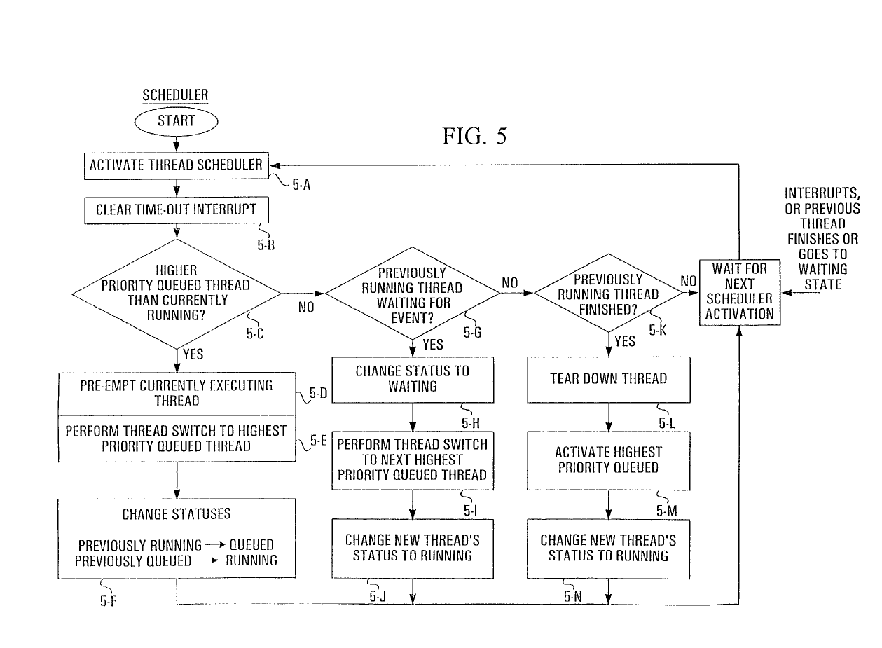

The scheduler 90 decides which thread to run next on the basis of the thread status table 110. It can be seen from the state diagram that the scheduler 90 becomes active when an interrupt service thread finishes or goes to WAITING state, when an application thread finishes (terminates) or goes to the WAITING state, and indirectly when either an interrupt service thread or application thread is instructed to be pre-empted due to an interrupt in which case state B is active on the way to state A. The function of the scheduler 90 is shown in flowchart form in FIG. 5. The first thing which occurs is the activation of the scheduler (step 5-A). The scheduler is activated after any interrupt occurs (including timeout) and has been processed by the support layer, after a thread terminates, or after a thread goes to the WAITING state. The scheduler clears the timeout interrupt if set (step 5-B). Generally speaking, each time the scheduler 90 is activated (step 5-A) if the thread scheduler 90 determines from the thread status table 110 that there is a thread with QUEUED status which has a higher priority than the thread which is currently RUNNING (YES Path, step 5-C), then the scheduler 90 will trigger a pre-emption of the currently executing thread (step 5-D), and perform a thread switch to the highest priority thread (step 5-E). Interrupt service threads are given a higher priority than application tasks. Thus, when any interrupt service thread has a QUEUED status, then a pre-emption of an application task which is RUNNING will occur. The scheduler 90 also changes the status of the previously RUNNING thread to QUEUED (step 5-F). The scheduler 90 is responsible for maintaining the status of the application threads, and for changing an interrupt service thread's status from QUEUED to RUNNING, and then to WAITING upon completion. As described below, the ISR 80 is responsible for changing an interrupt service thread's status from WAITING to QUEUED.

After pre-emption, the higher priority thread's (such as the interrupt service thread) status is changed by the scheduler 90 to RUNNING (step 5-F). The interrupt service thread is a Java thread and as such when it runs, it does so in the context of the Java debugging environment. If the interrupt service thread crashes, a conventional Java crash dump results. Finally, Java exceptions can be thrown and Java memory management is available, for example for object creation. However, objects can also be locked down through the use of static objects to avoid real-time problems associated with garbage collection.

If the previously RUNNING thread (this could be an interrupt service thread or an application thread) has been instructed to go to the WAITING state, typically to wait for the occurrence of some external event (often user input or a timer), (YES Path, step 5-G) then that thread's status is changed to WAITING (step 5-H). A thread switch to the next highest priority QUEUED status thread is performed (step 5-I), and the new thread's status is changed to RUNNING (YES Path, step 5-J). Similarly, if the previously running thread has finished (step 5-K), the finished thread is torn down (step 5-L), the highest priority QUEUED application thread is activated (step 5-M) and the next application thread's status is changed to RUNNING (step 5-N). Each time a time slice is given to an application thread, a timer is set to generate the timeout interrupt after the time slice is up. Alternatively, it might be permitted to process some predetermined number of byte-codes.

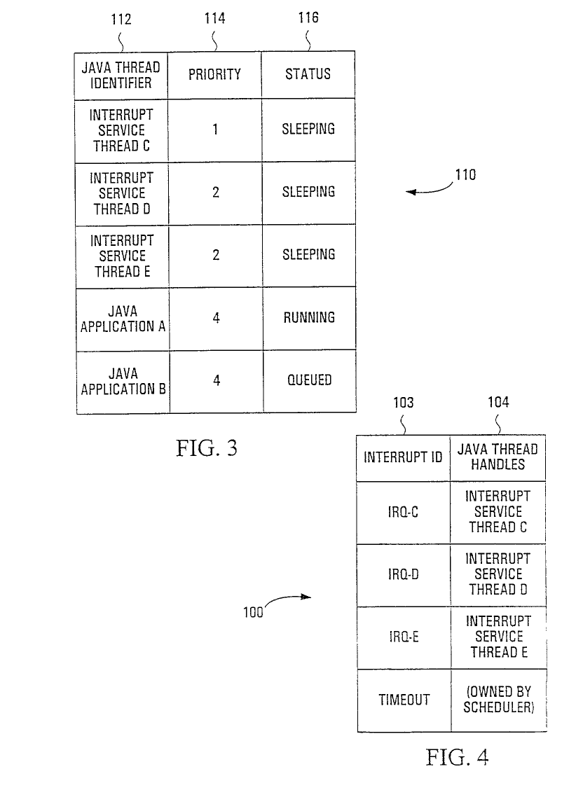

Referring now to FIG. 4, the ISR 80 maintains an interrupt service table generally indicated by 100 which maps interrupts 11 which may be generated by the interrupt sources 9 to hardware 2 to associated handles to Java interrupt service threads 84,86,88. The interrupt service threads 84,86,88 can register or deregister with the support layer 74 such that ISR 80 can activate them when a corresponding interrupt occurs as described below. Each interrupt has a respective interrupt ID in the left hand column 103 of the interrupt service table 100, and a respective Java thread handle in the right hand column 104 of the table. In the illustrated example, the interrupt service table includes the three interrupts having interrupt ID IRQ_C, IRQ_D and IRQ_E with corresponding interrupt service thread handles indicated to point to interrupt service thread C, interrupt service thread D, and interrupt service thread E respectively. The interrupt service table 100 also includes a record for the timeout interrupt. This is not mapped to any thread handle, but rather simply signifies it is time to return to the scheduler to perform a thread switch. Control is given immediately to the scheduler which round robins between all threads of the highest priority.

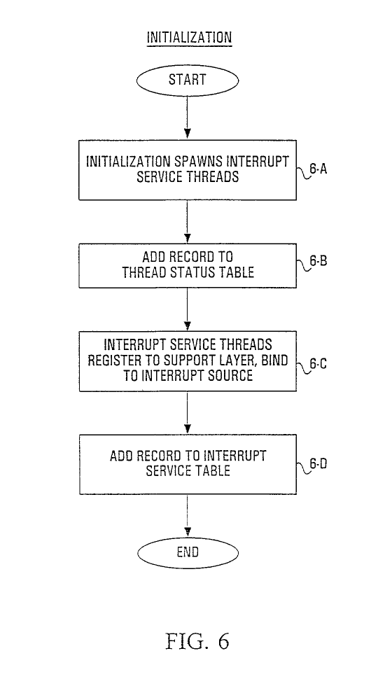

The interrupt service table 100 is created during initialization of the system. This initialization is shown in flowchart form in FIG. 6. The initialization spawns one new interrupt service thread per interrupt source to be serviced (step 6-A) (or per interrupt priority, or per interrupt). A new record is added for each thread thus spawned to the thread status table 110 (step 6-B). Each of the interrupt service threads registers to the support layer 74 (step 6-C) through a native call and passes two parameters to the native call: a handle to itself (the “this” pointer) and the interrupt it wants to bind to. The native call binds the thread handle to the selected interrupt source and adds a record to the interrupt service table 100 (step 5-D).

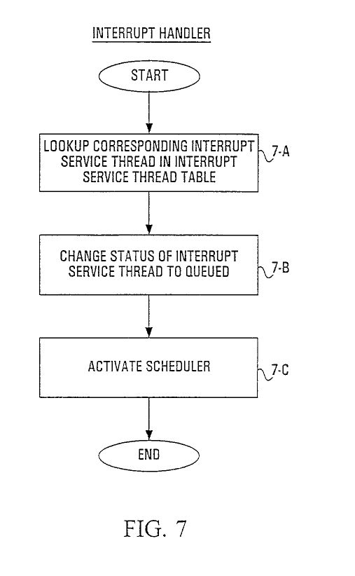

FIG. 7 shows the functions executed by the ISR 80 in flowchart form. The ISR 80 consists of a series of native functions implemented in the support layer 74. It runs with very little reliance on the JVM data structures, only making changes to the thread status table 110 as described and does not interact directly with any Java objects. The reason for this is that it is advantageous to keep the interrupt service routines from having to synchronize with garbage collection to the detriment of interrupt latency. Upon activation the ISR 80 looks up the corresponding interrupt service thread in the interrupt service thread table (step 7-A), if any. An interrupt awakens a WAITING interrupt service thread by changing the status of the thread in the thread status table 110 WAITING to QUEUED (step 7-B) and then activates the scheduler by forcing an immediate pre-emption. In the event a timer interrupt activated the ISR, no changes are made to the thread status table 110 and the scheduler is simply activated (step 7-C) to perform a thread switch amongst threads of equal highest priority. An awakened interrupt service thread deals with the interrupt and clears the interrupt upon completion. The ISR 80 is activated in hardware by the occurrence of any unmasked interrupt event, including a timeout interrupt. This is the only thing the ISR 80 does. It does not clear the interrupt condition. Also, as indicated above, the ISR 80 is not responsible for any of the other state transitions of any interrupt service thread. Once an interrupt service thread's status is changed in this manner, it will cause a pre-emption and be run by the scheduler 90 as described above. Processing of the interrupt is deferred to the interrupt service thread. The ISR 80 masks any interrupts from being processed which are of equal or lower priority than a currently processed interrupt. This mask is removed and any previous mask restored upon completion of the Java interrupt service thread.

A consequence of the above described priority system is that interrupts can be nested. For example, while processing a medium priority interrupt, if a high priority interrupt occurs, the ISR 80 changes the high priority interrupt's state to QUEUED. This causes the scheduler 90 to perform a pre-emptive context switch to the high priority interrupt service thread. The ISR 80 returns without clearing the interrupt condition, which is left to the interrupt service thread. Only after the high priority interrupt service thread is completed is the medium priority interrupt service thread resumed.

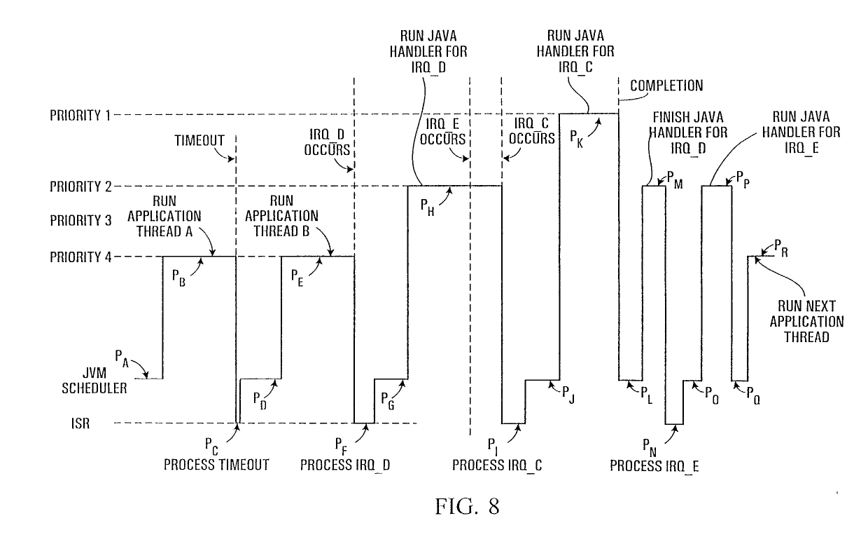

An example of this will be described with reference to FIG. 8. After initialization, the JVM scheduler is run during time period P_{A}. In the absence of any interrupt events, the first application thread is given a time slice P_{B} which expires upon the assertion of a timeout interrupt which activates the ISR during P_{C}. The processing of the timeout interrupt is basically void, only having the effect of reactivating the scheduler during time period P_{D}. In the absence of any interrupt events, the second application thread is given a time slice PE. In this example, it is assumed that before the second application thread times out, IRQ-D occurs (recall IRQ-D has priority 2) which activates the ISR during P_{F}. The ISR changes the status of interrupt service thread D to QUEUED and then immediately activates the scheduler which runs during interval P_{G}. The scheduler detects that interrupt service thread D has an QUEUED state and changes that state to RUNNING and runs the thread during interval P_{H}. It is now assumed that at some time during the processing of interrupt service thread D, IRQ_E occurs. This is masked since it has the same priority as IRQ_D. It is now assumed that at some time, during the processing of interrupt service thread D, IRQ_C occurs. This is not masked since it has a higher priority than IRQ_D and results in the ISR being activated during P_{I} which in turn changes the state of interrupt service thread C to QUEUED. The scheduler is then immediately run during P_{J}. The scheduler detects the highest QUEUED state thread is interrupt service thread C and as such that thread is run during P_{K}. Upon completion of that thread, the scheduler is reactivated during P_{L} and the scheduler reinvokes interrupt service thread D during P_{M}. Only upon completion of interrupt service thread D is IRQ_E unmasked. This activates the ISR during P_{N} which changes the state of interrupt service thread to QUEUED so that it is run during P_{P} after being activated by the scheduler during P_{O}. Finally, when upon completion, the scheduler is activated during P_{Q}, and the application thread selected by round robin from the highest priority QUEUED threads is given a time slice during P_{R}. The thread identifiers might be maintained in a linked list from higher priority to lowest.

During all the processing of these interrupts, the Java virtual machine was in user state, except for these short times where the ISR is informing the scheduler that the context has changed. If at any time there is a bug in the code, the standard debugging tools for Java tasks are usable to trace and troubleshoot. On the other hand, legacy systems would do all this hardware servicing at interrupt level, in which a fault is much less obvious.

Details of Interrupt Service Threads

Should the need arise for the interrupt service threads to access specific memory locations, such as hardware peripheral memory mapped registers, each thread can be supplemented with a respective native function to deal with the peripheral, implemented as part of the support layer. To access memory, these native functions may use direct memory access, however with this approach, the potential for corruption exists. Alternatively, the anchored arrays approach provided in applicant's copending application number entitled “Methods and Systems For Applications To Interact With Hardware” filed on the same date as this application may be used by the interrupt service threads to safely access hardware peripheral memory mapped registers with the full benefit of Java's security features.

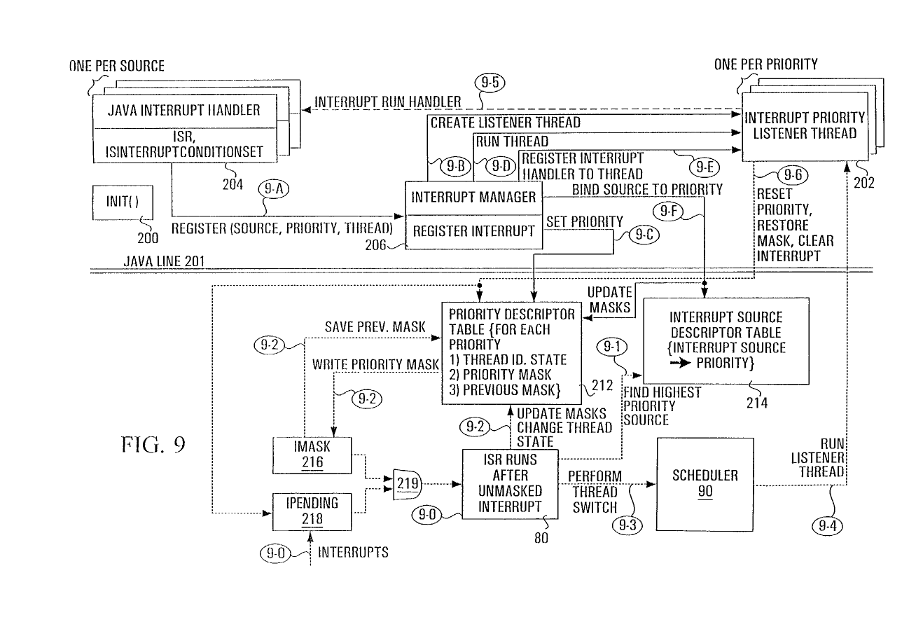

Appendix A includes pseudocode for an example implementation. This example implementation will now be described with reference to FIG. 9. In this implementation, rather than having an interrupt service thread (such as threads 84, 86, 88) for each interrupt, an interrupt priority listener thread 202 is provided for each priority which calls an appropriate interrupt specific Java or Java like function referred to as Java interrupt handler 204. The priority descriptor table 212 is analogous to the thread state table 110, and the Interrupt Source Descriptor table 214 is analogous to the interrupt service table 100.

Shown are objects and classes above the Java line 201, and native functions and structures below the Java line 201. Above the Java line 201 there is a function called inito 200 which is run upon initialization to set up the remaining structures which are introduced below (not shown in pseudocode). For each interrupt priority there is an interrupt priority listener thread 202 which is run when ever an interrupt of that priority occurs. For each interrupt source, there is Java Interrupt Handler 204 which performs processing of the interrupt at the Java level and which is run whenever an interrupt for that source occurs. There is an Interrupt Manager class 206 which contains the various registration functions enabling Java Interrupt Handlers 204 to be associated with particular sources and particular priorities.

Below the Java line 201 is the scheduler 90 which is responsible for allocating Java processing time between threads. There is a priority descriptor table 212 which stores for each priority, a thread identifier, a priority mask, and a previous mask. There is an interrupt source descriptor table 214 which maps each interrupt source to a corresponding priority. There is a register IPENDING 216 which represents the status of any actual interrupts. There is a register IMASK 218 for storing a mask of the interrupts. There is the top level ISR 80 which runs whenever there is an unmasked interrupt condition, as determined by the output of an AND logic function 219.

The steps executed to initialize the system are labelled steps 9-A through 9-F, while the steps executed during run time to process an interrupt are labelled as steps 9-1 through 9-6 and are indicated with dashed lines. The initialization steps will be described first. In step 9-A, each Java interrupt handler 204 registers to the Interrupt Manager 206 during inito 200. This results in the creation of an Interrupt Priority Listener Thread 202 for the interrupt handler's priority if one has not already been created, step 9-B. In step 9-C, the priority of the new thread 202 is set in priority descriptor table 212. In step 9-D, the new thread 202 may be run to pre-resolve Java references outside interrupt context. In step 9-E, the Java interrupt handler 204 is then registered to the thread 202, whether newly created or not. In step 9-F, the interrupt source is bound to the priority in the Interrupt Source Descriptor Table 214, which in turn updates all the priority masks in the Priority Descriptor Table 212 such that they prevent interrupts from interrupting the same or higher priority interrupts.

During run time, interrupts occur, and these will effect the contents of the IPENDING register 218. Only if an unmasked interrupt in IPENDING exists as determined by AND logic 219 is the ISR 80 run (step 9-0). In step 9-1, the ISR 80 determines the highest priority interrupt, and changes the state of the priority Listener Interrupt Thread 202 for that priority to QUEUED, saves any previous priority mask, and writes that priority's mask to the IMASK register 216. In step 9-3, the ISR 80 instructs the scheduler 90 to perform a thread switch which the scheduler does immediately. In step 9-4, the scheduler 90 performs a thread switch, and runs the Interrupt Priority Listener Thread 202 for the interrupt priority. The Interrupt Priority Listener Thread 202 determines from interrupt conditions which Java interrupt handler 204 to run and runs it in step 9-5. In step 9-6, after successful completion of the Java interrupt handler 204, where the interrupt is cleared (not shown in pseudocode), the previous MASK is restored to the IMASK register 216 by the interrupt priority listener thread 202, and the state of the interrupt priority listener thread 202 is returned to WAITING.

Numerous modifications and variations of the present invention are possible in light of the above teachings. For example, although described in the context of a Java environment, the present invention also finds applicability in other environments that are Java or Java like. It is therefore to be understood that within the scope of the appended claims, the invention may be practised otherwise than as specifically described herein.

APEENDIX A
// This example of a system assumes the following hardware resource:
// - One hardware interrupt controller with 32 interrupt sources, all maskable
// within the interrupt controller.
// - A user mode and an interrupt request (IRQ mode). Whilst in IRQ mode, the
// processor ignores further interrupt requests until interrupts are renabled
// Definitions:
// NUM_INT_SOURCES = 32, which is the number of hardware interrupt sources.
// NUM_PRIORITIES = 4, which is an arbitrary number of priorities.
// An interrupt priority listener is a thread associated with a given
// interrupt priority. The priority may be purely determined in software
// as drivers request to be assigned a given priority.
// Several interrupt sources may share this thread.
// Mention the Java and C layers and the purpose of each
class InterruptPriorityListener implements Runnable
{

// the isrEntryTable is used to hold a reference to drivers tied to this
// particular interrupt priority.
InterruptHandler isrEntryTable[];
// an InterruptPriorityListener must be aware of its own priority to retrieve the
// previous interrupt context.
InterruptPriorityListener( )
{

// In this example, we create a large enough table to hold all possible
// interrupt sources so we don't have to worry about running out of space.
isrEntryTable = new InterruptHandler[NUM_INT_SOURCES];

}
// insert a new interrupt handler in the table.
boolean public registerEntry( InterruptHandler h)
{

int i = 0;
while (isrEntryTable[i] != null)

i++;

// save the interrupt handler.
isrEntryTable[i] = h;
// the following calls are made to preresolve the method reference. Otherwise,
// there is a risk of real-time violation since the resolution of reference is not
// necessarily bounded in Java. It is assumed that handlers are well behaved and
// can survive a “dry invocation”.
h.isInterruptConditionSet();
h.isr();

}
// deregistering is optional in an embedded system and should be fairly obvious
// This is the waiting thread that will be woken up by the system when an interrupt
// that match the priority of this thread occurs. This routine will scan the table for
// the source that actually caused the interrupt, and then invoke the corresponding
// interrupt service routine.
public void run()
{

while(true)
{

// Suspend the thread until something happens.
try
{

Thread.sleep(0);

}
catch (InterruptedException){}
int i;
while (i < isrEntryTable.length)
{

if (isrEntryTable[i] == null)

continue;

if (isrEntryTable[i].isInterruptConditionSet()
{

isrEntryTable[i].isr();
// we stop scanning, since there will be only one interrupt source
// active the vast majority of the time.
break;

}
// restore interrupt mask
InterruptManager.imaskRestore(priority);

}

}//end of while

}

}
// The following methods are common to all interrupt handlers.
interface InterruptHandler
{

// this isr method is called by the service the interrupt
// It is the body of the interrupt service routine.
public void isr();
// isInterruptConditionset is used to find whether or not an interrupt source is
// requesting servicing.
public boolean isInterruptConditionSet();

}
// The SerialDriver class is an example of InterruptHandler which services
// one interrupt source. In this example, the isr simply echoes all characters.
class SerialDriver implements InterruptHandler
{

int source;
public SerialDriver()
// we assume the serial port peripheral has an irq bit in its status register.
public boolean isInterruptConditionSet()
{

if (MemoryAccess.read(UART_STATUS) & IRQ_BIT)
{

return true;

}
else
{

return false;

}

} // ISR is responsible for clearing interrupt condition.
public isr()
{

// read the receiver not empty flag until it is empty
while( MemoryAccess.read(RX_NOT_EMPTY)
{

// read the data and write it back to the port. (This ultimately clears
// the interrupt condition).
MemoryAccess.write(DATA, (MemoryAccess.read (DATA));

}

}

}
// this set of utility classes is required to access a hardware peripheral
// from a Java driver.
class MemoryAccess
{

public static native int read(int address);
public static native void write (int address, int data);

}
class InterruptManager
{

InterruptPriorityListener ipl[];
InterruptManager(numPriorities)
{

// create interrupt priority listener table
ipl = new InterruptPriorityListener[numPriorities];

}
registerInterrupt(int source, int priority, InterruptHandler h)
{

// if the listener does not exist, create it, bind it to priority and

start the listener thread.

if (ipl[priority] == null)
{

ipl[priority] = new InterruptPriorityListener( priority);
// set the priority of the thread, and start the tread.
bind PriorityToThread(priority, ipl[priority].getThreadId( ));
ipl[priority].setThreadPriority(priority);
ipl[priority].start( );

}
// then, register the InterruptHandler to the listener
ipl[priority].registerEntry(h);
// finally, bind the interrupt source to the priority at the native level.
bindSourceToPriority(int source, int priority);

}
// deregistering is optional and should be obvious to the reader..
// those functions are native and described below.
static native imaskRestore(int priority);
static native bindSourceToPriority(int source, int priority);
static native bindPriorityToThread(int priority, Thread

}
/////////////////////////////////////
/// native routines.
// assumption: there is a global interrupt mask register. We call it IMASK.
struct Thread
{

// state can be RUNNING, QUEUED or WAITING
int state;
// the Context contains information that pertains to the structure of a
// thread. It is where the context of execution of threads are stored and
// retrieved between thread switches.
struct Context *context;
// the Threads are linked together in priority order, highest priority first.
// Methods of creating and managing a sorted linked-list are well known and will
// not be described here.
struct Thread *next;

}
struct InterruptSourceDescriptor
{

int priority;

}
struct InterruptSourceDescriptor
interruptSourceDescriptorTable[NUM_INT_SOURCES];
struct PriorityDescriptor
{

struct Thread thread;
int priorityMask;
int saveMask;

}
struct PriorityDescriptor priorityDescriptorTable[NUM_PRIORITIES];
// the imaskSave routine is used to save the current interrupt context and
// enter a new (higher priority) interrupt context. It is used for preemptive
// interrupts.
void imaskSave(int priority)
{

priorityDescriptorTable[priority].saveMask = IMASK;
IMASK = priorityDescriptorTable[priority]. priorityMask;

}
void InterruptManager_imaskRestore(int priority)
{

IMASK = priorityDescriptorTable[priority].saveMask;

}
void InterruptManager_bindSourceToPriority(int source, int priority)
{

// set the prioritysource of the
interruptSourceDescriptorTable[source].priority = priority;
// update all the priority masks

}
void InterruptManager_bind PriorityToThread (int priority, struct Thread *t)
{

priorityDescriptorTable[priority].thread = t;

}
isr()
{

// mask ints by finding the interrupt source.
int p = findHighestQUEUEDSource();
imaskSave(p);
// wake up thread
priorityDescriptorTable[priority].thread.State = QUEUED;
// command a preemptive thread switch
performThreadSwitch();
// return. The thread scheduler will take it from there. At the end of the isr,
// the InterruptListener will call InterruptManager.imaskRestore()

}

We claim:

1. A processing arrangement comprising an apparatus adapted to process interrupts with threads.

2. A processing arrangement according to claim 1 having an interface for receiving interrupts and comprising:
a virtual machine having a scheduler for performing thread switching between a plurality of the threads; and
a thread designated to handle each interrupt.

3. A processing arrangement according to claim 2 further comprising:
an interrupt service routine adapted to receive interrupts, and upon receipt of an interrupt to cause the scheduler to awaken a thread designated to handle the interrupt.

4. A processing arrangement according to claim 2 wherein each thread is assigned a thread priority and the scheduler performs thread switching on the basis of thread priorities.

5. A processing arrangement according to claim 3 wherein the interrupt service routine causes the scheduler to awaken a thread designated to handle the interrupt by changing the Java thread's status.

6. A processing arrangement according to claim 3 further comprising:
a thread status table maintained by the scheduler for storing a status and priority for each thread;
wherein the interrupt service routine causes the scheduler to awaken the thread designated to handle the interrupt by changing the thread's status.

7. A processing arrangement according to claim 3 further comprising an interrupt service table used by the interrupt service routine to map each possible received interrupt to the thread designated to handle the interrupt.

8. A processing arrangement according to claim 4 wherein each time the scheduler is invoked, the scheduler identifies whether there is a thread which is waiting to be run which has a higher priority than a currently executing thread, and if so performs a thread switch to that thread.

9. A processing arrangement according to claim 5 wherein each Java thread's status is either WAITING, QUEUED meaning it is waiting to be run, or RUNNING meaning that it is currently executing.

10. A processor with an interface for receiving interrupts comprising:
a scheduler for performing thread switching between a plurality of application layer threads;
at least one application layer thread designated to handle the interrupts.

11. A processor according to claim 10 further comprising:
an interrupt service routine adapted to receive the interrupts, and upon receipt of an interrupt to cause the scheduler to awaken a particular one of the application layer threads designated to handle the interrupt.

12. A processor according to claim 11 wherein each application layer thread is assigned a thread priority and the scheduler performs thread switching on the basis of thread priorities.

13. A processor according to claim 12 wherein the interrupt service routine causes the scheduler to awaken a particular one of the application layer threads designated to handle the interrupt by changing a status of the thread.

14. An interrupt service routine adapted to be activated upon an interrupt event, and to activate an application layer thread to handle the interrupt event, without clearing the interrupt event.

15. An interrupt service routine according to claim 14 wherein activating the application layer thread comprises changing a status of the application layer thread.

16. An interrupt service routine according to claim 14, wherein the application layer thread is a Java thread.

17. A Java thread scheduler comprising:
a thread state memory for indicating a state and priority of each of a plurality of Java threads, the Java threads including interrupt service threads adapted to handle interrupt events; and
a thread switching mechanism for switching between the plurality of Java threads on the basis of the state and priority of the Java threads.

18. An application layer thread adapted to handle an interrupt event by running to completion or until pre-emption by a higher priority application layer thread, and adapted to clear the interrupt event upon completion.

19. A processor comprising:
an interface adapted to receive interrupts;
a scheduler adapted to perform thread switching between a plurality of application layer threads;
at least one application layer thread designated to handle the interrupts.

20. A processor according to claim 19 further comprising:
an interrupt service routine adapted to receive the interrupts, and upon receipt of an interrupt to cause the scheduler to awaken a particular one of the application layer threads designated to handle the interrupt.

21. A processor according to claim 19 wherein each application layer thread is assigned a thread priority and the scheduler performs thread switching on the basis of thread priorities.

22. A processor according to claim 21 wherein the interrupt service routine causes the scheduler to awaken a particular one of the application layer threads designated to handle the interrupt by changing a status of the thread.

23. A processor according to claim 19 wherein interrupts have one of a plurality of priorities, and wherein a respective application layer thread is designated to handle all interrupts of a given priority.

24. A processor according to claim 23 further comprising a respective application layer function designated to handle each interrupt;
wherein upon occurrence of a particular interrupt the respective application layer thread is adapted to call the application layer function designated to handle the particular interrupt.

25. A Java system comprising:
a plurality of interrupt priority listener threads implemented in Java;
an interrupt manager which binds the interrupt priority listener threads to interrupt sources.

26. A Java system according to claim 25 further comprising:
a scheduler for scheduling the interrupt priority listener threads and other Java application threads;
a native interrupt service routine run asynchronously with the other Java application threads when an interrupt occurs which causes the scheduler to awaken a particular interrupt priority listener thread bound to the interrupt which occurred.

27. The processing arrangement according to claim 1 wherein the threads comprise Java threads.
